(19) United States
(12) Patent Application Publication
(10) Pub. No.: US 2002/0094396 A1
(43) Pub. Date: Jul. 18, 2002

(54) Extended life balloon

(75) Inventors: William Ward, Manteno, IL (US); Mark Van Dyke, Crete, IL (US); Robert Schulteis, Manteno, IL (US)

Correspondence Address: FITCH EVEN TABIN AND FLANNERY, 120 SOUTH LA SALLE STREET, SUITE 1600, CHICAGO, IL, 60603-3406, US

(73) Assignee: M & D BALLOONS, INC.

(21) Appl. No.: 10/015,977

(22) Filed: Dec. 13, 2001

Related U.S. Application Data
(63) Continuation-in-part of application No. 09/655,947, filed on Sep. 6, 2000.

(51) Int. Cl. B32B 1/02

(52) U.S. Cl. 428/35.3; 428/35.4

(57) ABSTRACT

Balloon films for buoyant toy balloons include a support layer, a gas barrier layer, and a metalization layer. In one embodiment, the barrier layer also serves as a support layer for the metalization. In other embodiments, the support layer is additional to the barrier layer. A sealant layer is added to allow balloon manufacture using commercial techniques.

### CROSS REFERENCE TO RELATED APPLICATION

This application is a continuation-in-part of prior application Ser. No. 09/655,947, filed Sep. 6, 2000, which is hereby incorporated herein by reference in its entirety.

### BACKGROUND OF THE INVENTION

1. Field of the Invention

The present invention pertains to toy balloons which are buoyant, containing a lighter-than-air gas, and in particular to such balloons formed from barrier composite films of the type having improved gas barrier properties.

2. Description of the Related Art

So-called floating or buoyant balloons are well known and have been met with enthusiastic response. Typically, such balloons are fabricated at a manufacturing site and are shipped in a deflated condition to a point of sale, such as a greeting card store or an amusement facility. The balloons are then inflated, assembled with other balloons or products, and prepared for immediate delivery to a customer. As part of the preparation process, tethers or other restraints are usually applied to the buoyant balloons to limit their floating height. While this type of merchandising has been met with ready commercial acceptance, it has been found desirable to offer balloons for sale at a department store or shopping outlet, and some consumers prefer to have the toy balloon displayed in a pre-inflated condition, ready for check out. Because of the relatively limited life of inflated buoyant balloons (that is, the life over which the balloons remain at an inflation level which is alternative to consumers) personnel would be required on an ongoing basis to maintain desired inflation levels of the balloons on display. As a result, there is a reluctance by mass merchandisers to incur the added cost of such maintenance operations.

### SUMMARY OF THE INVENTION

Lighter-than-air balloons or so-called “helium” balloons are known to include clear films which incorporate a helium barrier and metalized balloons on which metalization is applied to a non-helium barrier substrate. The useful “life” of these balloons (that is, the time period over which they present an appearance attractive to the consumer) has been known to extend from several days to about one week before the balloon needs re-inflation. Usually, inflated balloons are not regarded as having a substantial “shelf” life, but rather are usually inflated on demand for delivery to a customer.

With the present invention, lighter-than-air balloons are provided having a heretofore unattained shelf life of approximately one month or more, without requiring maintenance or other intervention. Accordingly, with balloons according to principles of the present invention, balloon manufacturers can provide fully completed balloons to mass merchandisers and other retailers.

It is an object of the present invention to provide a buoyant toy balloon having an improved barrier to lighter-than-air gas.

Another object of the present invention is to provide a buoyant balloon which, when inflated, maintains inflation pressure at a consumer acceptance or satisfaction level for an extended period of time, at least as long as three weeks, preferably, up to one month or more.

These and other objects according to principles of the present invention are provided in a lighter-than-air toy balloon having an extended life when inflated, formed from a multiple layer balloon film comprising:

a metalization layer sufficient to provide an optical density defined as log 100/T, where T represents the percentage of light transmitted through the metalized layer, of at least 2.4;

a helium gas barrier layer; and

a sealing layer for thermal sealing to form a balloon seam.

### BRIEF DESCRIPTION OF THE DRAWINGS

FIG. 1 is a fragmentary cross-sectional view of a balloon film according to principles of the present invention;

FIG. 2 is a fragmentary cross-sectional view of another balloon film according to principles of the present invention;

FIG. 3 is a fragmentary cross-sectional view of a further balloon film according to principles of the present invention;

FIG. 4 is a fragmentary cross-sectional view of a prior art balloon film;

FIG. 5 is a fragmentary cross-sectional view of another prior art balloon film;

FIGS. 6-9 are fragmentary cross-sectional views of balloon films according to principles of the present invention;

FIG. 10 is a graph of inflation data for balloons according to principles of the present invention;

FIG. 11 is a perspective view of an arrangement for obtaining inflation test data;

FIG. 12 is an end view thereof;

FIG. 13 is a schematic view showing preparation of a balloon prior to an inflation test procedure; and

FIG. 14 is a side elevational view of a balloon shown installed in an inflation test apparatus.

### DETAILED DESCRIPTION OF THE PREFERRED EMBODIMENTS

The present invention is directed to novelty of toy balloons which are filled with a gas which is lighter-than-air. Accordingly, the toy balloons are made buoyant, or floating upon sufficient inflation. Typically, these balloons are constructed of two or more gores or balloon film layers which are overlaid, one on the other, and sealed at their outer periphery, so as to form a pressure-tight vessel. The balloons are also provided with inflation valves, typically of the self-sealing type, which extend along a balloon neck, entering the hollow interior cavity of the balloon. These types of balloons are known to lose inflation pressure in a relatively short time, on the order of approximately 6-10 days. Upon study, it has been determined that the deflation is generally not associated with the self-sealing valve, but rather is attributed to passage of the inflation gas (usually helium) through the balloon films forming the pressure vessel. Thus, attention has been turned to the gas barrier properties of balloon films used to form buoyant balloons.

Generally speaking, buoyant balloons are of two broad types, clear and metalized. Illustrated in FIG. 5 is one example of a composite film used in the manufacture of buoyant, clear balloons. The composite balloon film shown in FIG. 5 is commercially available under the trade designation 525 HEPTAX, available from the Gunze Corporation of Japan. The balloon film, generally indicated at 10, includes multiple film layers bonded together to form a composite film structure. It should be mentioned that film 10, as with many films employed in the toy balloon industry, is usually of a general purpose nature, being developed for commercial application in other fields, such as food packaging.

The outermost layer 12 of composite film 10 is made of NYLON and has a thickness of approximately 3 microns. Bonded to layer 12 is a barrier layer 14 comprised of commercially known EVOH material, which functions as the primary gas barrier of the composite structure. Layer 14 has an approximate thickness of 5 microns. A layer 16 of NYLON material is bonded to the inner surface of layer 14 and has a thickness of approximately 3 microns. Bonded to the inner surface of layer 16 is a heat sealing layer 18, preferably of polyethylene, with a thickness of approximately 14 microns. When employed for use in a toy balloon, an outer surface 22 of layer 12 faces the consumer, whereas the opposed inner surface 24 faces toward the interior, hollow volume of the balloon pressure vessel.

As mentioned, the primary gas barrier layer 14 is comprised of EVOH material, which is known to be sensitive to humidity. That is, when the gas barrier layer 14 is subjected to sufficiently high levels of humidity for a significant amount of time, its gas barrier properties are known to decline. When the composite film 10 is employed for use in toy balloons, the amount of decrease in gas barrier properties, if not addressed, is unacceptable (in that balloons made of the material and subjected to the presence of humidity tend to deflate at a rapid rate, quickly rendering the toy balloon to an unsaleable, or a post-sale condition, which very quickly becomes unacceptable to the consumer). It is believed that the outer layer 12 of NYLON material, although itself somewhat susceptible to humidity, is added to protect or shield the inner gas barrier layer 14 from environmental humidity surrounding the finished balloon product. Prior to assembly of the composite film 10 into a commercial toy balloon product, the composite film is typically stored in bulk quantity at a manufacturing site, awaiting the balloon production process. It is important that the gas barrier layer 14 be protected during this storage period, although the situation can be controlled by the balloon manufacturer, with the provision of controlled humidity storage conditions.

A second type of buoyant balloon is made from a metalized composite film, such as that illustrated in FIG. 4 and indicated by the reference numeral 30. When employed for use in toy balloons, composite film 30 is constructed with a support layer 32 of NYLON material having a thickness on the order of 12 microns (48 gauge), vacuum metalized so as to deposit aluminum vapor on its outer surface. The resulting metalized layer 34 is built up to achieve a variable controlled thickness. Typically, the thickness of the metalized layer 34 is determined in accordance with the optical density exhibited by the metalized support layer. The optical density (O.D.) of plastic films is related to the percentage of transmitted light through the metalized film.

O.D.=log 100/T,

where T represents the percentage of light transmitted through the metalized film.

The following table relates % light transmission and resistivity to various levels of optical density.

TABLE 1

| Thickness | % Light | Optical | Resistivity |
|---|---|---|---|
| Angstroms | Transmitted | Density | ohms/square |
| 30.5 | 10.00 | 1.00 | 6.70 |
| 71.1 | 5.01′ | 1.30 | 3.98 |
| 84.0 | 3.16 | 1.50 | 3.32 |
| 101.6 | 1.99 | 1.70 | 2.86 |
| 121.9 | 1.00 | 2.0 | 2.35 |
| 134.6 | 0.63 | 2.20 | 2.05 |
| 159.9 | 0.40 | 2.40 | 1.80 |
| 188.0 | 0.25 | 2.60 | 1.55 |
| 218.0 | 0.19 | 2.80 | 1.31 |
| 254.0 | 0.10 | 3.00 | 1.18 |
| 292.0 | 0.53 | 3.20 | 0.98 |
| 343.0 | 0.040 | 3.40 | 0.83 |
| 394.0 | 0.025 | 3.60 | 0.72 |
| 457.0 | 0.015 | 3.80 | 0.062 |
| 505.0 | 0.005 | 4.00 | 0.54 |
| 554.0 | 0.004 | 4.20 | 0.46 |

The NYLON support layer 32 in one commercial embodiment has a typical thickness of approximately 12 microns (48 gauge). In order to form a satisfactory seal when employed in toy balloon manufacture, the metalized support film is provided with a sealant layer, such as polyethylene, having a thickness on the order of 14 to 16 microns. In order to facilitate bonding of the sealant layer 36 with the support layer 32, the exposed surface of support layer 32 is coated with a commercial bonding primer 38.

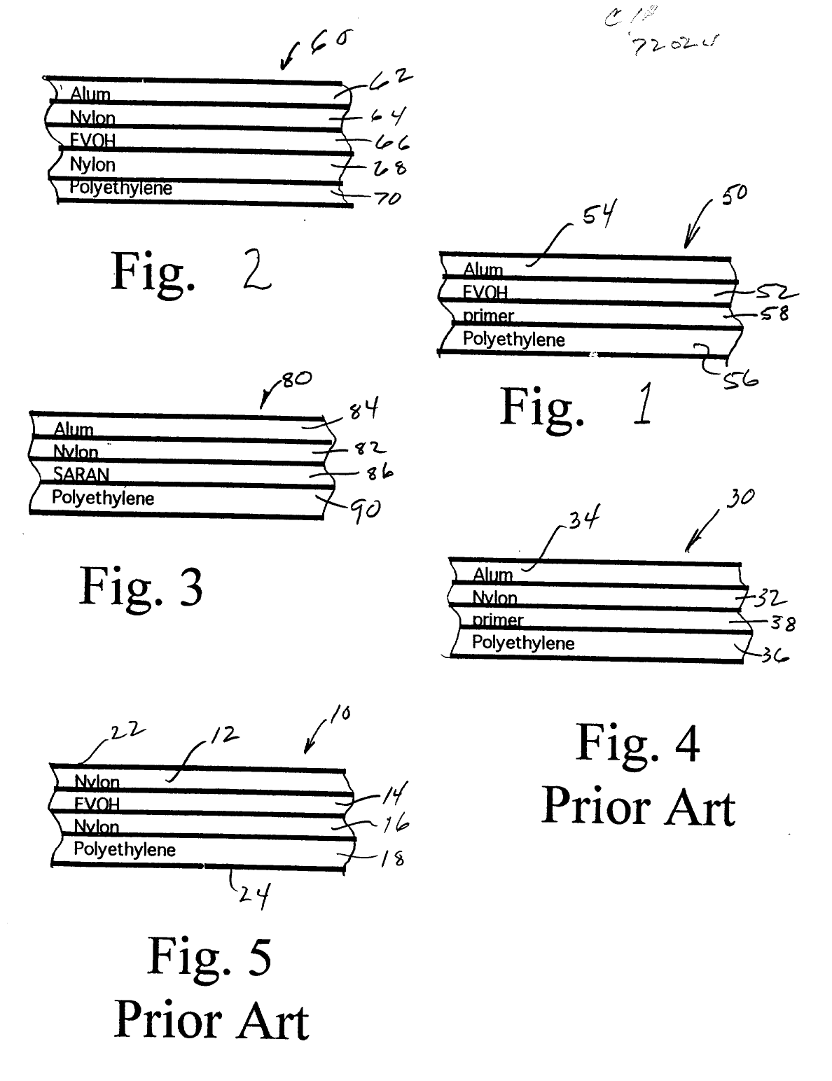

Balloons constructed from the composite films of the type illustrated in FIGS. 4 and 5 have a relatively short life, as mentioned above. Improvements to the gas barrier properties of balloon films is provided by the present invention. Referring, for example, to FIG. 1, a composite film 50 employs a barrier layer of EVOH material, preferably having a 32% ethylene content and commercially available under trade designation EF-EXL, available from the EVAL Corporation of Japan and New York, U.S.A. The barrier film 52 is subjected to a vacuum metalizing process. Preferably, the process is carried out by a commercial vacuum metalizing facility, which metalizes a wide variety of objects. It is generally preferred that the resulting metalized layer 54 yield an optical density ranging between 2.4 and 3.2 and most preferably ranging between 2.4 and 2.6. The metalization layer 54 typically has a thickness ranging between 1.6 and 2.92 microns and most preferably ranges between 1.6 and 2.0 microns. The metal vapor employed in the metalization process preferably comprises aluminum, attractive for its light weight and therefore minimal detraction of the balloon's buoyancy.

As mentioned above, balloon films are heat sealed at their outer periphery to form a pressure-tight vessel. Accordingly, a heat sealing layer 56 is required, because of the poor thermal bonding properties of barrier layer 52. In order to aid in the bonding of the sealant layer, a commercial bonding primer layer 58 is employed. Preferably, the sealant layer is applied in an extrusion coat with linear low density polyethylene such as that employing a DOW 3010 resin.

The sealant layer 56 has a typical thickness of approximately 16 microns and preferably has a thickness ranging between 13 and 19 microns. Reducing the thickness of heat sealant layer 56 below minimum values has been found to substantially reduce the viability of balloon seals produced according to commercial standards. Thicker sealant layers, beyond the maximum given, have been found to contribute excessively to the overall weight of the balloon, substantially reducing its buoyancy.

As mentioned, barrier layer 52 is sent to an outside facility for vacuum metalization according to an optical density specified by the balloon manufacturer. Initial quantities of metalized barrier film were found to be commercially unacceptable for balloon manufacture, although usually satisfactory vacuum metalization techniques (similar to those employed, for example, to produce prior art composite film 30) were employed. Balloon films are typically provided in massive rolls, frequently up to four feet in width. In order to prevent unacceptable waste in the balloon manufacture process, balloon patterns are designed and carefully placed with respect to the web, so as to obtain the maximum number of commercial balloon products per lineal foot of composite film.

The metalized barrier film initially obtained from the commercial vacuum metalization service was found to have distorted (i.e., irregularly receded) edges. As a consequence, the centerline of the balloon film was constantly shifted somewhat as the composite film web was paid out and, more significantly, the usable width of the composite film web was erratically reduced from point to point resulting in unacceptable waste. It was determined that the vacuum metalization process should be carried out with greater than normal cooling of the underlying layer being metalized. In this instance, the layer being metalized is a gas barrier layer, preferably of EVOH material, which, as mentioned, is sensitive to moisture. In subsequent tests, cooling of the underlying web during vacuum metalization was carried out using water cooled steel rollers and, accordingly, attention had to be paid to web speed and other controllable factors during vacuum metalization to reduce the exposure time of the EVOH material to heat to avoid deterioration of the barrier.

As can be seen in FIG. 10, toy balloons manufactured from the composite film 50 have substantially improved gas barrier properties, attaining a heretofore unattainable useful life of at least 38 days. Referring to FIG. 10, a graph of balloon inflation performance is shown, with a measure of inflation level being tracked on the vertical axis, and the number of test days after inflation being tracked on the horizontal axis. The measured inflation condition, shown in the vertical axis of FIG. 10, is observed according to test apparatus, which will be described herein with reference to FIGS. 11-14. Performance curves lying at the top of FIG. 10 show greater inflation retention than performance curves lying toward the bottom of FIG. 10. Line 51 in FIG. 10 indicates a consumer satisfaction standard determined by sales and marketing experience. For the balloons being tested, the standard deflation level was determined to be −76 mm.

The performance curve 50′ represents the measured performance of toy balloons constructed to commercial standards using the composite balloon film 50 shown in FIG. 1. Two test balloons, constructed with prior art composite film 30, were observed. The first balloon, represented by performance curve 30′, proved to be unacceptable at day 9 of the test. The second sample balloon, indicated by performance curve 30″, was able to complete the 38-day test period, but was observed to be commercially unacceptable at day 18. The performance curve 50′, lying at the top of FIG. 10, shows a substantial improvement over balloons constructed from conventional metalized balloon films constructed from the balloon film 30 shown in FIG. 4. By comparison to performance curves 30′ and 30″, the performance curve 50′ shows a continuously robust improvement, with commercial life exceeding 38 days.

Referring now to FIG. 2, composite film 60 is constructed by vacuum metalizing the commercially available 525 HEPTAX film illustrated in FIG. 5. Included in composite film 60 is a metalization layer 62 developed to produce an optical density ranging between 2.4 and 3.2, and preferably between 2.4 and 2.6 (see Table 1). It was anticipated that the heat of metalizing may render the 525 HEPTAX film too stiff, and more prone to micro leakage. In a high volume, mass production industry it is important that production costs be held to a reasonable level. Accordingly, it was important to establish the long term performance of balloons having composite films metalized using conventional cost-effective processes. Water-cooled steel, roller metalization techniques, although, less common than other metalization techniques, still promise the cost effectiveness needed to obtain a competitive advantage. The underlying outer layer 64 of NYLON material, the gas barrier layer 66 of EVOH material, the NYLON support layer 68 and the polyethylene sealant layer have respective thicknesses of 3, 5, 3 and 14 microns.

With reference to FIG. 10, two test balloons were constructed from composite film 60. The performance curves for these two balloons are indicated at 60′ and 60″ in FIG. 10. As can be seen, the performance indicated by curves 60′ and 60″ is substantially improved over balloons of similar size and shape constructed from conventional composite film 30.

The second test balloon, represented by performance curve 60″, was observed to have a 23-day commercial life, while the balloon of performance curve 60′ was observed to have a commercial life of 28 days. Theoretically, a thicker metalization layer, that is, one yielding a higher optical density, should provide greater gas barrier improvements. However, the balloon represented by performance curve 60′, metalized to achieve an optical density of 2.5, performed better than the balloon represented by performance curve 60″ which was metalized to achieve an optical density of 3.0. The two performance curves 60′ and 60″ are, however, closely spaced to one another and have the same general curved shape. Reasons for the anomaly in observed performance curves 60′ and 60″ are not fully understood, although it is suspected that the metalization process to attain the thicker (3.0 optical density) coating for the balloon of performance curve 60″ may have adversely affected the underlying shielding NYLON layer 64, and perhaps the gas barrier layer 66. It is important that the balloon manufacturing techniques be carried out using cost effective conventional methods and apparatus. Balloons constructed from composite film 60 were found to be more sensitive to heat, when heat-sealed to form a pressure vessel. Accordingly, the duration of heating during formation of the peripheral heat seal was shortened as much as possible, consistent with reliable seal integrity.

Turning now to FIG. 3, composite film 80 includes a support layer 82 of NYLON material. Support layer 82 has a typical thickness of approximately 12 microns and can range in thickness between 10 and 14 microns. The metalization layer 84 has a thickness needed to attain the desired optical density, which preferably ranges between 2.4 and 3.2, and most preferably between 2.4 and 2.8. After metalization, a barrier layer of SARAN coating 86 is bonded to the inside surface of support layer 82. This allows metalization to be applied to the more rigid support layer 82, allowing the more delicate barrier layer 86 to avoid the rigors of heat and web tension associated with conventional vacuum metalization techniques. The barrier layer 86 has a thickness ranging between 2 and 5 microns and preferably has a thickness of approximately 3 microns. Although other barrier layers, such as the EVOH barrier layer 52 in FIG. 1, can be made thicker, the SARAN material of composite film 80 is substantially heavier, to an extent which would adversely affect buoyancy of balloon products constructed from composite film having a similarly thick layer of SARAN material. The metalized SARAN coated NYLON film requires a heat sealant layer in order to perform satisfactorily as balloon film. A heat sealant layer 90, preferably of polyethylene material having a thickness of approximately 13 to 17 microns, is added to the metalized SARAN coated NYLON composition.

As mentioned above, FIG. 10 plots balloon inflation condition with respect to test duration. The balloon inflation data of FIG. 10 is measured in terms of millimeters of deflection, determined according to test apparatus generally indicated at 100 in FIGS. 11-12, with FIG. 11 showing a sample balloon 104 being measured in the test apparatus. With additional reference to FIG. 12, apparatus 100 includes an upright or riser 110 supported by a base 112 having a width of approximately 11 inches and a depth (extending into the plane of the paper) of approximately 6 inches. A felt pad 114 extends to cover the active area of base 112, as will be seen herein.

An adjustable clamp 116 is secured to riser 110 and is movable in vertical directions. A pivot arm 118 has a knife edge 120 at its free end and is pivotally connected at 122 to clamp 16. Pivot arm 118 has a length of approximately 30 inches and is preferably made of aluminum, as is riser 110 and base 112. Pivot arm 118 has a depth (extending into the plane of the paper) of approximately ¾ inch. A plate 130 is attached to the underside of pivot arm 120 and has a width of approximately 11.75 inches and a depth (extending into the plane of the paper) of approximately 6 inches. The depth of plate 130 is centered about the depth of pivot arm 118. The bottom, active surface of plate 130 carries a felt pad 134. An upstanding ruler 140 is located adjacent the free end of pivot arm 118.

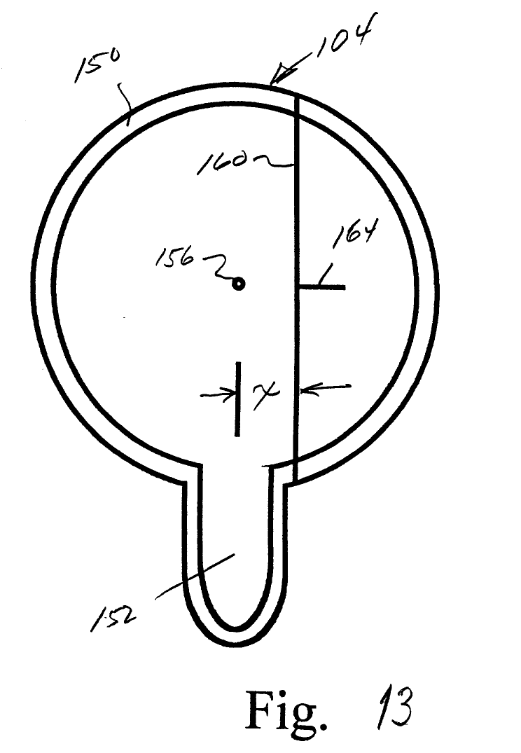

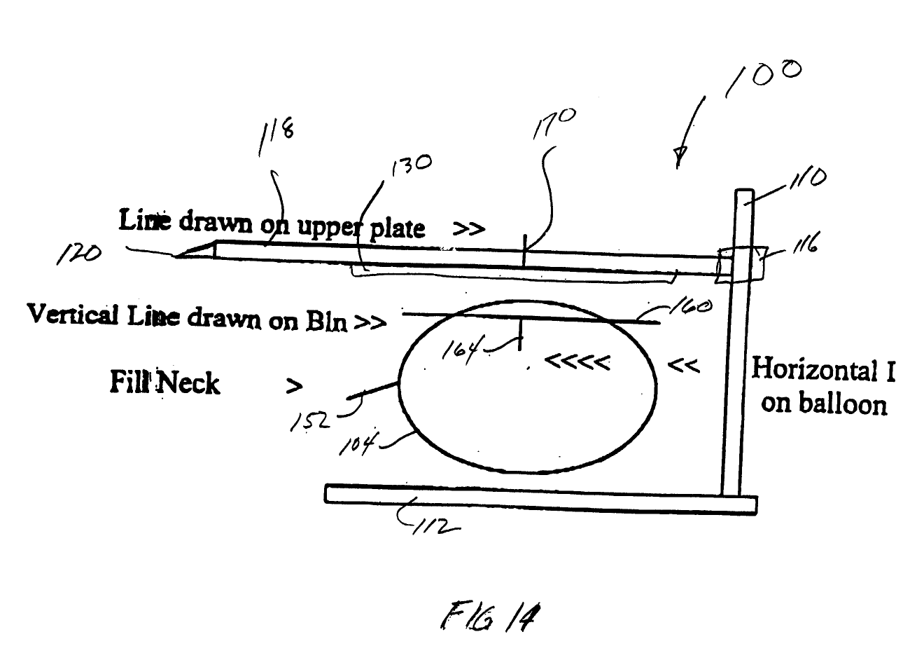

With reference to FIG. 13, test balloon 104 has an outer peripheral seal 150 and a neck 152. As shown in FIG. 13, test balloon 104 has a generally round or circular body with a center 156. A reference line 160 is drawn in the direction of length of neck 152 and is laterally offset from the center of the balloon by an offset distance x. In the preferred embodiment, offset distance x has a value of 3 inches, equal to one-half the depth of plate 130. A site line 164 is drawn normal to reference line 160, extending along a radial line from the center of the test balloon. With reference to FIG. 14, a sight line 170 is drawn on the upper surface of plate 130 in a direction generally perpendicular to the length of pivot arm 118.

As mentioned, plate 130 and base 114 have depths extending into the plane of the paper of 6 inches. The longitudinal center lines of plates 130 and base 114 are aligned with one another so as to have corresponding depths of 3 inches extending to either side of their center line. Test balloon 104 is inserted between plate 130 and base 112 in the manner indicated in FIG. 14, with reference line 160 aligned with a lateral edge of plate 140. Balloon 104 is then adjusted until sight line 164 on the balloon is aligned with sight line 170 on plate 130. Clamp 116 is then adjusted to bring pivot arm 118 to a horizontal position, with the weight of the pivot arm being carried by the test balloon. The clamp 116 is thereafter maintained in a fixed position about riser 110.

The ruler 140 is then brought adjacent the knife edge 120 of the pivot arm and an initial distance measurement is taken. Preferably, the initial distance measurement is set to a numeric value of zero. Deflation of the balloon will result in increasing negative numbers, with knife edge 120 being allowed to descend toward the bottom of ruler 140.

If the balloon is subjected to temperatures increased beyond those of inflation conditions, balloon 104 may inflate (due to the pressure-sensitive helium) so as to bring knife edge 120 a positive distance, above the zero mark on ruler 140. Positive and negative millimeters of deflection are thereby obtained, and these are represented on the vertical axis of FIG. 10. As will be appreciated, values of measured deflection of pivot arm 118 will reflect corresponding, repeatable changes in inflation conditions, primarily understood to represent a volume change of the hollow balloon interior. Measurements of customer satisfaction with regard to balloon inflation are, of necessity, subjective reflecting the personal preferences of the consumer. However, over considerable years of experience trained operators are able to estimate a balloon's saleability or customer attractiveness by visual estimation.

As can be seen in FIG. 10, an abrupt deflation is experienced between days 2 and 11. As will be appreciated by those skilled in the art, helium-filled balloons have inflation characteristics severely dependent upon ambient temperature. The drop in inflation conditions indicated in FIG. 10 between days 2 and 11 occurred when the test environment dropped to unusually low temperatures. As can be seen in FIG. 10, on day 11 the various balloon inflation conditions returned when the cold temperature conditions were discovered and removed. The balloon constructed from composite film 50 and having a performance curve 50′ was located in a different test environment with substantially constant normal room temperatures. Accordingly, performance curve 50′ indicates a continuous, regular change in the performance curve during days 2-11 and, were the other test balloons not subjected to unusually cool temperatures, their performance curves would generally track the shape of performance curve 50 between days 2 and 11.

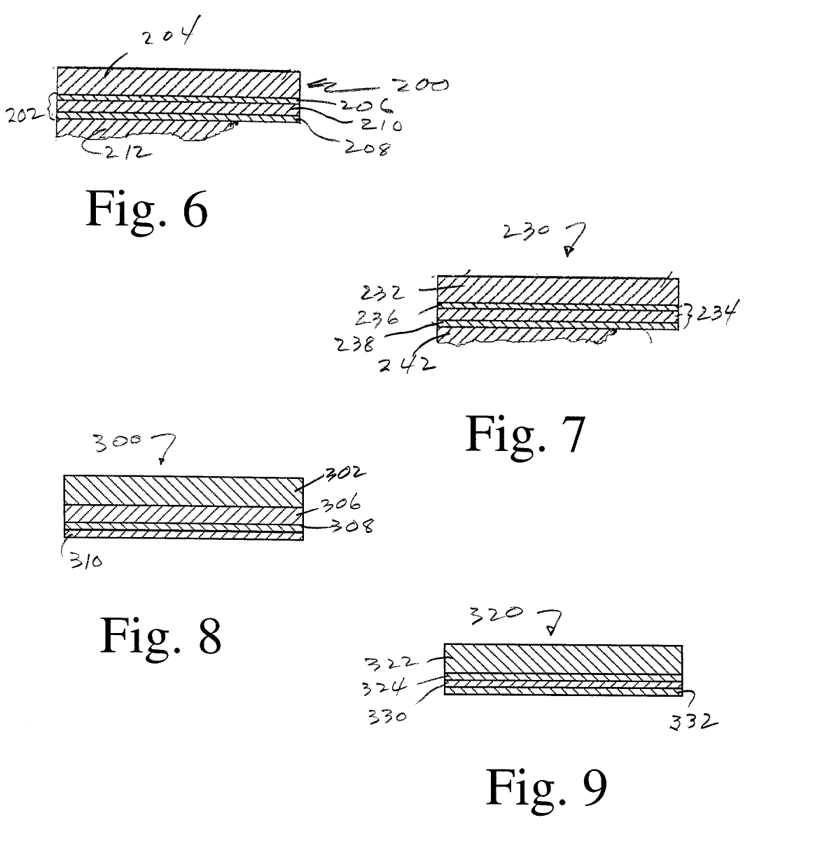

Turning now to FIG. 6, a balloon film 200 includes a composite base film 202 to which a polyethylene sealant layer 204 is applied, so as to face the balloon cavity. Guideline layers 206, 208 are located on either side of a barrier layer 210. Most preferably, barrier layer 210 is made of EVOH material having a thickness of 3 microns, and the nylon layers 206, 208 have a thickness of approximately 6 microns. A texturing layer 212 may also be provided, if desired, for use in conjunction with an embossing process such as the “holographic” embossing process commercially available from SpectraTec Technologies, Inc. of Los Angeles, Calif. The composite base film 202 may be assembled layer by layer or may be commercially obtained as a GUNZE 315N film.

Turning now to FIG. 7, a balloon film 230 includes a polyethylene layer 232 applied to a composite base film 234. Nylon layers 236, 238 have a thickness of approximately 5 microns and are located on either side of an EVOH layer, also of approximately 5 microns thickness. An optional texturing layer 242 may also be included, if desired. The composite base film 234 may be commercially obtained as GUNZE 315E film.

In several embodiments constructed according to principles of the present invention, EVOH material is employed as a gas barrier. The use of EVOH material in a commercial balloon production facility requires special processing to prevent compromising the desired gas barrier properties. For example, it has been found necessary to seal balloon films with equipment operating at unusually long dwell times, on the order of two to three times longer than expected. Also, as will be appreciated by those skilled in the art, conventional balloon sealing dies frequently cause small size hot spots which are tolerated by conventional balloon films. Surprisingly, such hot spots have been found to compromise the desired gas barrier properties and, for reasons of commercial reliability, heat sinks must be added to portions of the balloon sealing areas where temperatures are elevated. Further, folding of completed balloons employing EVOH materials must be carried out with unusual care to avoid sharp bending radii. Crossing folds, where balloons are folded in two different directions, must be protected with additional pressure resisting techniques in order to prevent compromise of the gas barrier properties.

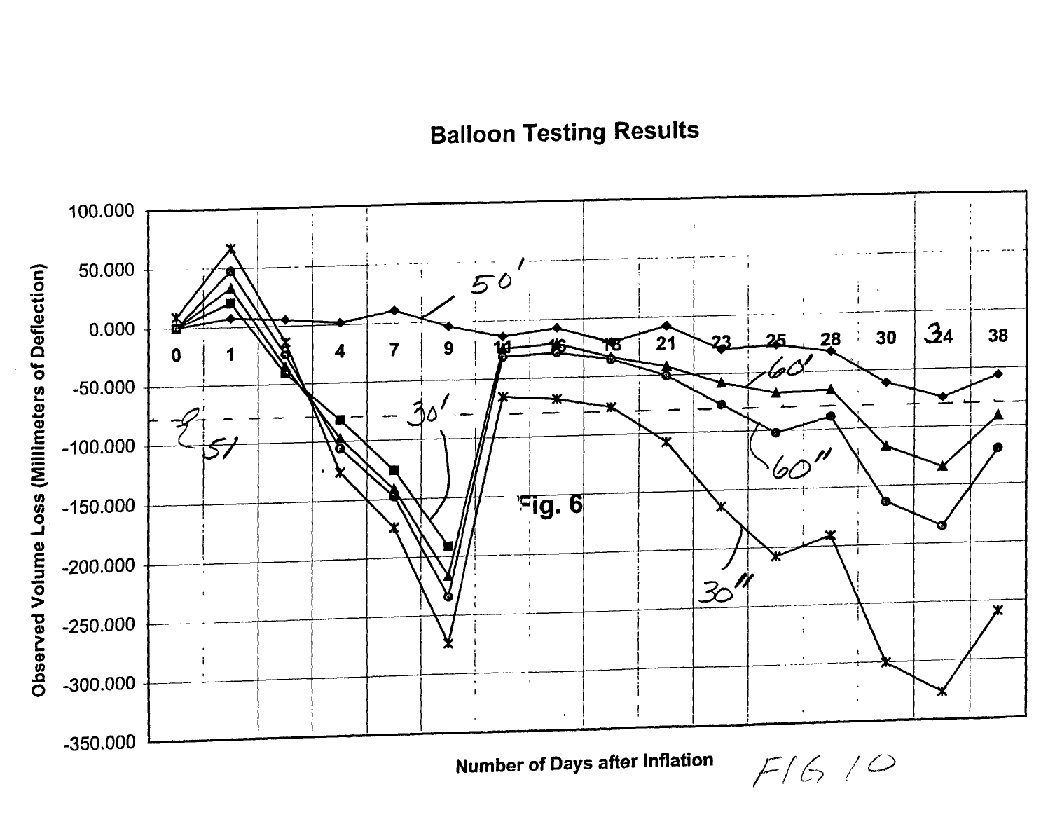

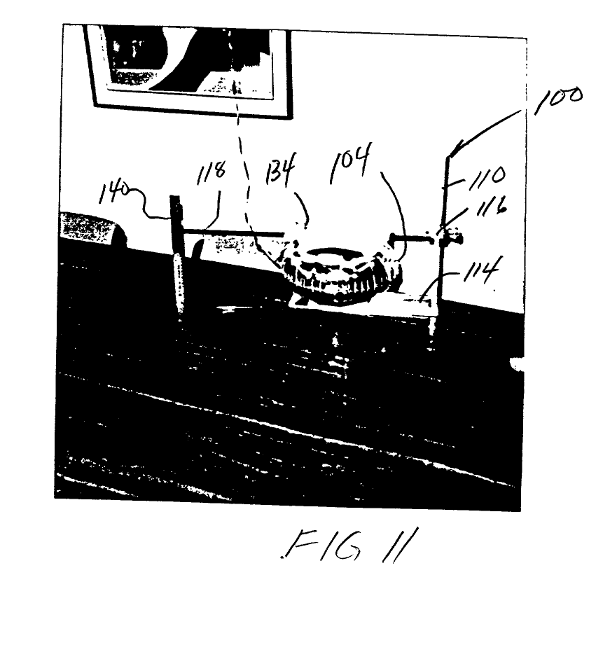

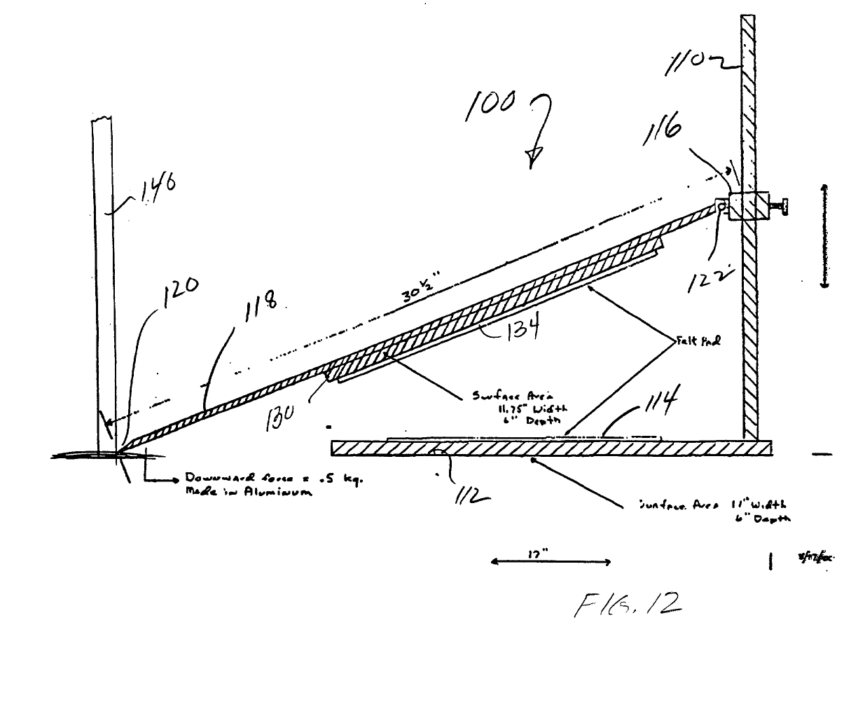

Principles of the present invention can also be applied to non-transparent balloons (such as metalized balloons of the type in popular use today) to increase their post-inflation longevity. Turning now to FIGS. 8 and 9, and initially to FIG. 8, a balloon film 300 includes a polyethylene layer 302 applied to a composite base film 304 comprised of layers 306, 308. Layer 306 comprises a polyvinyl chloride (PVC) material, preferably SARAN film, while layer 308 preferably comprises a nylon material. A metalized layer 310, preferably aluminum, is applied to the composite base layer, as shown. Test balloons constructed with film 300 were inflated to commercial standards and remained commercially viable for a surprisingly long time, in excess of two months. The combination of the PVC, nylon and metalizing layers cooperate to prevent micro-leaks experienced in balloons filled with lighter-than-air gas.

Similar results were obtained with a balloon film 320, shown in FIG. 9, comprising a polyethylene layer 322, a nylon layer 324, a zinc metalizing layer 330, and an aluminum layer 332. Individual metalized coatings, applied in a manner different than that of the present invention, has been found to exhibit commercially unacceptable micro-leakage tendencies. In carrying out the present invention, the metalizing layers were applied using cost-effective conventional techniques. Without benefit of the present invention, each individual metalizing layer exhibits small size voids or interstices leading to micro-leakage. However, by applying the multiple metalizing layers in a two-stage metalizing chamber with the zinc layer applied first, micro-leakage is reduced to the point where test balloons constructed according to principles of the present invention have remained commercially acceptable for as long as two months after inflation to conventional commercial standards.

As can be seen from the above, the present invention provides buoyant balloons made from conventional materials and employing established cost effective manufacturing techniques with heretofore unattainable prolonged inflated shelf life. The present invention contemplates use of commercially available gas barrier film materials, with examples of more common materials being given above. As a further quality measure, balloons constructed according to the present invention should be as buoyant as possible, considering the balloon's surface area and internal volume. Balloons, according to principles of the present invention, suffer little or no penalty with respect to buoyancy.

The drawings and the foregoing descriptions are not intended to represent the only forms of the invention in regard to the details of its construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation, the scope of the invention being delineated by the following claims.

What is claimed is:

1. A lighter-than-air toy balloon having an extended life when inflated, formed from a multiple layer balloon film comprising:
a metalization layer sufficient to provide an optical density defined as log 100/T, where T represents the percentage of light transmitted through the metalized layer, of at least 2.4;
a helium gas barrier layer; and
a sealing layer for thermal sealing to form a balloon seam.

2. A balloon of claim 1 further comprising at least one support layer joined to said gas barrier layer.

3. A balloon of claim 2 comprising two support layers, one on each side of said gas barrier layer.

4. A balloon of claim 1 wherein said metalized layer comprises aluminum.

5. A balloon of claim 1 wherein said gas barrier layer comprise EVOH.

6. A balloon of claim 2 wherein said support layer comprises NYLON.

7. A balloon of claim 1 wherein said sealing layer comprises polyethylene.

8. A balloon of claim 1 wherein said sealing layer comprises a coating of SARAN material.

9. A balloon of claim 1 wherein said balloon further comprises a bonding primer between said gas barrier layer and said sealing layer.

10. A lighter-than-air toy balloon having an extended life when inflated, comprising:
a metalized layer;
a gas barrier layer directly or indirectly supporting said metalized layer; and
a sealant layer.

11. A balloon of claim 10 further comprising a bonding primer between said gas barrier layer and said sealing layer.

12. A lighter-than-air toy balloon having an extended life when inflated, comprising:
a layer of aluminum;
a gas barrier layer of EVOH material joined to said aluminum layer; and
a polyethylene sealing layer joined to said gas barrier layer.

13. A balloon of claim 12 wherein aluminum layer has a thickness ranging between 1.6 microns and 2.9 microns.

14. A balloon of claim 13 wherein said gas barrier layer has a thickness ranging between 10 and 14 microns.

15. A balloon of claim 14 wherein said polyethylene sealing layer has a thickness ranging between 14 and 19 microns.
